(19) United States
(12) Patent Application Publication
(10) Pub. No.: US 2010/0065526 A1
(43) Pub. Date: Mar. 18, 2010

(54) PERFORABLE CLOSURE FOR A CONTAINER, MOULD AND METHOD FOR CARRYING OUT SAID CLOSURE

(75) Inventors: Roberto Consolaro, Arzignano (IT); Angelo Consolaro, Arzignano (IT)

Correspondence Address: LAUBSCHER & LAUBSCHER, P.C., 1160 SPA ROAD, SUITE 2B, ANNAPOLIS, MD, 21403, US

(73) Assignee: BREVETTI ANGELA S.R.L., Arzignano, VI (IT)

(21) Appl. No.: 11/993,133

(22) PCT Filed: Jul. 18, 2006
(86) PCT No.: PCT/IB2006/001963

§ 371 Date: Dec. 3, 2009

(30) Foreign Application Priority Data
Jul. 19, 2005 (IT) BO2005A 000483

(51) Int. Cl. B65D 41/50; B29C 49/48; B29C 49/00

(52) U.S. Cl. 215/247; 425/525; 264/500

(57) ABSTRACT

A perforable closure for a container, is provided with at least a annular portion (2) fit to joint the container and connected to an end portion (3), perforable by means of a perforator (P) of an outflow or the like.

At least the annular (2) and end (3) portions of said closure (1) are integral.

### TECHNICAL FIELD

The present invention relates to the field of the containers and it refers to a perforable closure for a container particularly for a container containing drugs or fluid to give to a human or animal body.

The present invention refers furthermore to a mould and to the method to carry out said closure.

### BACKGROUND ART

There are waterproof know closures including a perforable membrane, generally made of synthetic elastic material, applied to the mouthpiece of a bottle by means of a capsule, generally made of aluminium, whose central portion is perforated or removable to allow an operator to connect an outflow for phleboclysis or hypodermoclysis to the bottle perforating it on the membrane by means of a perforator of said outflow.

A drawback of said closures consists in that, being constituted by several elements of different materials, they are difficult to be made and they are expensive.

Further drawback of said known closures consists in that they cannot hold the perforator provoking the risk of accidental detachment of the outflow or the risk of leakage due to excessive inclinations of the perforator.

Further drawback consists in that the interstices between the membrane and the capsule of said known closures can become dirty and/or contaminated and difficult to be cleaned and to be disinfected.

### DISCLOSURE OF THE PRESENT INVENTION

An object of the present invention is to propose a simple and economic perforable closure for a container.

Other object is to propose a closure carried out integral and made of a single material.

Further object is to propose a closure able to hold the perforator of the outflow with enough force and to prevent excessive oscillations avoiding the risks of accidental unthreading and dripping.

Other object is to propose a closure without receptacles and easy to be cleaned and to be disinfected in the perforation area.

Further object is to propose a closure applicable to a container, for instance, made of plastic or glass, or carried out integral with the container made of thermo-mouldable plastic.

Other object is to propose a mould and a method to carry out said closure.

### BRIEF DESCRIPTION OF THE DRAWINGS

The characteristics of the invention are highlighted in the following with particular reference to the attached drawings, in which:

FIG. 1 shows an axonometric and partial view of the perforable closure object of the present invention and an outflow whose perforator is in proximity of the perforation area of the closure;

FIG. 1B shows a schematic plan view of the end portion of the closure of FIG. 1;

FIG. 2 shows a partial side view of the outflow of FIG. 1 and a view of the closure of FIG. 1 sectioned by an axial plane in a condition prior to perforation;

FIG. 3 shows a partial side and partial sectioned view of the closure and of the outflow of FIG. 1 in a perforated condition;

FIG. 4 shows a view of the closure of FIG. 2 sectioned by an axial plane inclined in respect to the section plane of the FIG. 2;

FIG. 5 shows a enlarged view of the closure of FIG. 4 sectioned by the plane V-V;

FIG. 6 shows a plan view of the closure of FIG. 1 whose portions carried out by distinct members of a mould, are shown mutually detached;

FIG. 7 shows a partial section view of a member of the mould to carry out the closure.

### BEST MODE OF CARRYING OUT THE INVENTION

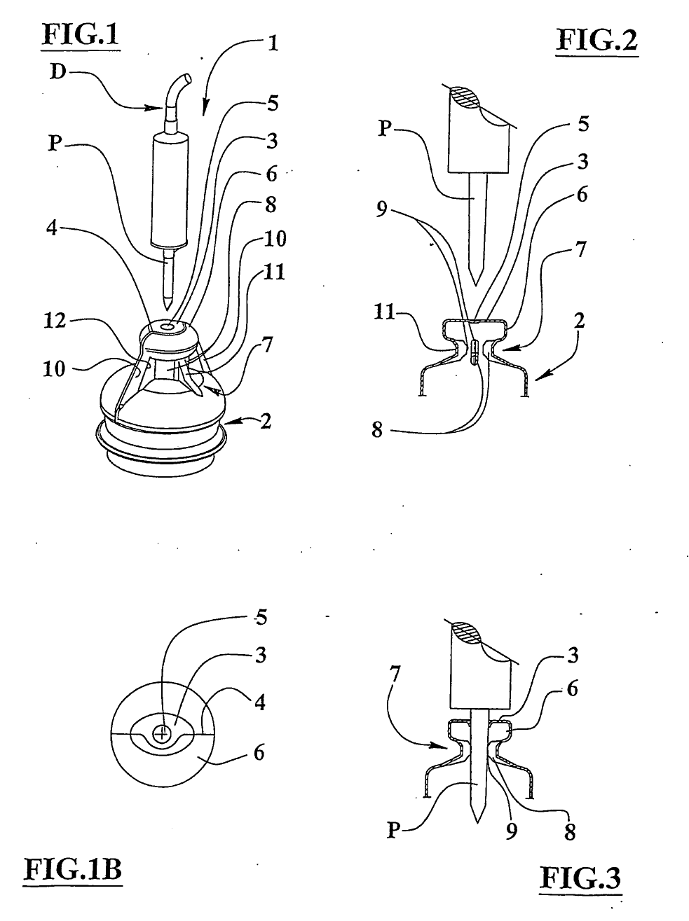

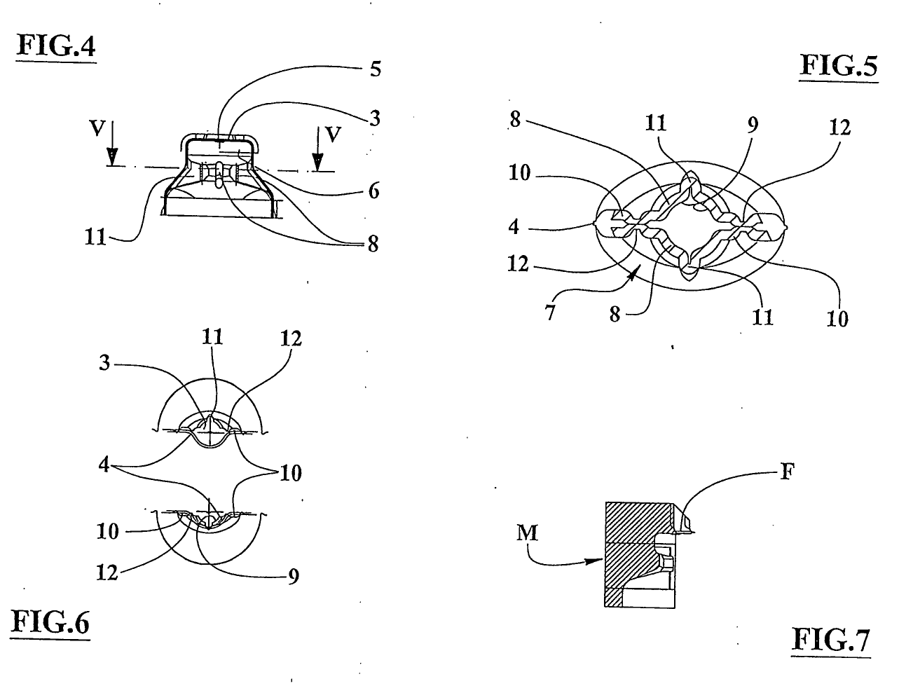

With reference to FIGS. 1-5 and 1B, numeral 1 indicates the perforable closure for a container object of the present invention.

The closure 1 is equipped with an annular portion 2, for integral forming or for interconnection with the container.

The annular portion 2 is connected, by means of a side portion 7, to an end portion 3 perforable by means of a perforator P of an outflow or the like.

The annular portion 2, the side portion 7 and the end portion 3 are carried out integral and made of thermo-mouldable plastic.

The end portion 3 is nearly flat and without moulding junctions 4 or without irregularity and it is centrally provided with a depression 5 for the friendly positioning of the perforator P. Said perforator P, for instance, consists of a plastic body provided with a slight conicity and with a point in which a duct of the respective outflow flows, for instance of the kind for phleboclysis or similar.

The end portion 3 is made at an end of a hollow end body 6 of the closure 1 having approximately cylindrical shape, spherical, rotation ellipsoid or similar shape and flowing inside the annular portion 2.

The end portion 3 has approximately elliptic, oval, circular or similar shape.

The side portion 7 comprises a plurality of narrowing means 8 protruding inside of the closure and fit to match with the side portion of the perforator P in a penetration condition of this latter in the closure 1.

Each narrowing mean 8 has an internal cylindrical wall portion 9 coaxial to the closure and carried out on the wall of the side portion 7.

The number of the narrowing means 8 is four and they are mutually separated by at least a pair of mutually opposite first ribs 10 and by a pair of second ribs 11 orthogonal to the first ribs 10.

The ribs, first 10 and second 11, extend themselves outward the closure 1 on planes containing the longitudinal axis of said closure 1.

The first ribs 10 are internally hollow and made on the wall of the closure, furthermore, they have side restrictions 12 parallel to their external rectilinear edge. The side restrictions 12 divide the internal volume to each first rib 10 in a first volume almost closed and with elongated shape and in a second volume in communication with the internal volume of the closure.

The second ribs 11 are made in the wall of the closure 1 and are internally hollow or solid.

The first ribs 10 extend from the end body 6, along the side portion 7 up to the annular portion 2 and the second ribs 11 extend along the side portion 7 up to the annular portion 2 or vice versa.

In alternative the invention also provides that the first and second ribs are at least approximately equal.

The first ribs 10 or/and the second ribs 11 confer to the side portion 7 an elasticity sufficient to allow the expansion toward the outside of the narrowing means 8 and to immobilize the perforator P in the perforated condition with a big force.

The moulding junctions 4 of the closure 1 run along the external edge of the first ribs 10 that extend from the end body 6.

The annular portion 2 is predisposed to the seal fixing with the container or, in alternative, is carried out integral with the same container.

The operation of the closure provides that an operator sets the point of the perforator P in the central depression 5 of the end portion 3 and maintaining the perforator approximately aligned to the axis of the closure, acting an axial force causing the breakage of the end portion 3, penetrating the perforator in the closure up to the match of the side wall of the perforator with the inner cylindrical wall portions 9 of the narrowing mean 8 which stop the exit and the oscillation of said perforator with enough force to prevent the accidental unthreading and to prevent the liquid dripping of the container between the end portion of the closure and the perforator.

The mould for carrying out the perforable closure schematized, and divided in its portions of moulding, in FIG. 6 comprises at least two members, one of which, shown in FIG. 7, is equipped with a forming portion F of the whole perforable end portion 3. Besides the two members of the mould, of type for “blow moulding”, have respective central and side concave shapes cooperating for the forming of the end body 6 and of the first ribs 10 extending from said end body 6.

The method for carrying out the perforable closure provides to form at least the closure 1 starting from a tubular element made of semi-fluid thermoplastic material so-called “Parison” by means of the blowing technique called “blow moulding.”

The method provides also to form the closure and the container integral starting from the same “Parison”.

An advantage of the present invention is provide a perforable closure for a simple and economic container.

Other advantage is to provide a closure carried out integral and made of a single material.

Further advantage is to provide a closure able to hold with enough force the perforator of the outflow and to prevent excessive oscillations avoiding the risks of accidental unthreading and dripping.

Other advantage is to provide a closure without receptacles and easy to be cleaned and disinfected in the perforation area.

Further advantage is to provide a closure applicable to a container, for instance made of plastic or glass, or carried out said closure integral with the container made of thermo-formable plastic material.

Other advantage is provide a mould and a method to carry out the closure.

1. Perforable closure for a container, provided with at least an annular portion (2) fit for connecting the closure to the container and connected to an end portion (3) perforable by means of a perforator (P) of a outflow or the like; said closure (1) being characterized in that at least the annular (2) and end (3) portions are integral.

2. Closure according to claim 1 characterized in that the end portion (3) is nearly flat and without junctions (4) or irregularity.

3. Closure according to claim 1 characterized that the end portion (3) is centrally provided with a depression (5) for the positioning of the perforator (P).

4. Closure according to claim 1 characterized in that the end portion (3) is made at the end of an end body (6) of the closure (1) having approximately cylindrical, spherical, or rotation ellipsoid shape or the like.

5. Closure according to claim 1 characterized in that the end portion (3) has approximately elliptical, oval, circular shape, or the like.

6. Closure according to claim 1 characterized in that the annular (2) and end (3) portions are mutually connected by means of a side portion (7).

7. Closure according to claim 6 characterized in that the side portion (7) comprises a plurality of narrowing means (8) protruding inside the closure and fit to match with the side portion of the perforator (P) in a penetration condition of this latter inside the closure (1).

8. Closure according to claim 7 characterized in that each narrowing means (8) has an inner cylindrical wall portion (9) coaxial to the closure and made on the wall of the side portion (7).

9. Closure according to claim 7 characterized in that the narrowing means (8) are mutually separated by at least a pair of opposite first ribs (10), internally hollow and made in the wall of the closure.

10. Closure according to claim 9 characterized in that the narrowing means (8) are also mutually separated by a couple of second ribs (11) orthogonal to the first ribs (10) and internally hollow or solid and made in the wall of the closure (1).

11. Closure according to claim 10 characterized in that the first (10) and second (11) ribs are outward extended in respect to the closure (1) on planes containing the longitudinal axis of said closure (1).

12. Closure according to claim 4 characterized in that the first ribs (10) or the second ribs (11) extend from the end body (6), along the side portion (7) up to the annular portion (2).

13. Closure according to claim 4 characterized in that the second ribs (11) or the first rib (10) extend along the side portion (7) up to the annular portion (2).

14. Closure according to claim 12 characterized in that the first ribs (10) and/or the second ribs (11) confer to the side portion (7) a sufficient elasticity to allow the expansion toward the outside of the narrowing means (8) and to immobilize the perforator (P) in the perforated condition with a big force.

15. Closure according to claim 2 characterized in that the junctions (4) run along the external edge of the first ribs (10) extending starting from the end body (6).

16. Closure according to claim 9 characterized in that the first ribs (10) have side restrictions (12) parallel to the external edge of the first ribs (1) the same.

17. Closure according to claim 1 characterized in that the annular portion (2) is fir for the seal fixing to the container.

18. Closure according to claim 1 characterized in that it is integral with the container.

19. Mould for carrying out the perforable closure of claim 1 characterized in that it comprises at least two members, one of which is provided with a forming portion (F) of the whole perforable end portion (3).

20. Mould according to claim 19 characterized in that it comprises at least two cooperating members to form the end body (6) and the first ribs (10) that extend starting from said end body (6).

21. Mould according to claim 19 characterized in that it is “blow moulding” type.

22. Method for carrying out the perforable closure of claim 1 characterized in that it forms at least the closure (1) starting from a tubular element made of semi-fluid thermoplastic so-called “Parison” by means of a blowing technique called “blow moulding”.

23. Method according to claim 22 characterized in forming the closure and the container integral starting from the same “parison”.
